(19) United States
(12) Patent Application Publication
(10) Pub. No.: US 2024/0220775 A1
(43) Pub. Date: Jul. 4, 2024

(54) INFORMATION PROCESSING SYSTEM AND INFORMATION PROCESSING METHOD

(71) Applicant: SONY GROUP CORPORATION, TOKYO (JP)

(72) Inventors: JUN NISHIKAWA, TOKYO (JP); MASATO ISHII, TOKYO (JP); TAKUYA NARIHIRA, TOKYO (JP)

(21) Appl. No.: 18/567,456

(22) PCT Filed: Dec. 27, 2021
(86) PCT No.: PCT/JP2021/048707

§ 371 Date: Dec. 6, 2023

(30) Foreign Application Priority Data
Jun. 15, 2021 (JP) 2021-099770

(51) Int. Cl. G06N 3/045

(52) U.S. Cl. CPC G06N 3/045

(57) ABSTRACT

Provided is an information processing system that performs processing related to a subjective evaluation of data generated using a machine learning model. An information processing system includes a system feedback acquisition unit that acquires generation data and evaluation information based on an evaluation model for the generation data, a system feedback presentation unit that presents the generation data and the evaluation information, a user feedback acquisition unit that acquires a user evaluation for the generation data or the evaluation information, and an output unit that outputs the user evaluation acquired by the user feedback acquisition unit.

### TECHNICAL FIELD

The technology (hereinafter, “the present disclosure”) disclosed in the present specification relates to an information processing system and an information processing method that perform processing related to evaluation of data generated using a machine learning model.

### BACKGROUND ART

Machine learning is a technique for causing a computer to learn a large amount of data and automatically constructing a model and an algorithm that perform operations such as data classification and prediction. For example, it is possible to obtain an identification model that analyzes data such as an image, a voice, and a text and a generation model that newly generates data such as an image, a voice, and a text by machine learning. The model is configured by, for example, a neural network. Recently, a technique related to a deep neural network (DNN) in which the neural network is deep-learned has been remarkably developed.

For example, a generative adversarial network (GAN) is known as a data generation technique using a machine learning model (See, e.g., Non-Patent Document 1.). The GAN includes a generator that generates data and a discriminator that identifies authenticity of the data, and mutual learning between the generator and the discriminator enables the generator to generate data whose authenticity cannot be identified by the discriminator.

On the other hand, data reflecting the user's subjectivity or preference may be required. The discriminator in the GAN can determine the authenticity of the data but cannot evaluate the subjectivity of the user. Therefore, in the GAN, data reflecting the subjectivity and preference of the user cannot be generated.

Furthermore, learned perceptual image patch similarity (LPIPS) is known as an index for evaluating image quality of a generated image, but is not an index indicating whether or not the generated image reflects the subjectivity or preference of the user.

### CITATION LIST

### Non-Patent Document

Non-Patent Document 1: I. Goodfellow et al., “Generative adversarial nets”, Advances in neural information processing systems, pp. 2672-2680, 2014

### SUMMARY OF THE INVENTION

### Problems to be Solved by the Invention

An object of the present disclosure is to provide an information processing system and an information processing method that perform processing related to a subjective evaluation of data generated using a machine learning model.

### Solutions to Problems

The present disclosure has been made in view of the problems described above, and a first aspect thereof is an information processing system including:
a system feedback acquisition unit that acquires generation data and evaluation information based on an evaluation model for the generation data;
a system feedback presentation unit that presents the generation data and the evaluation information;
a user feedback acquisition unit that acquires a user evaluation for the generation data or the evaluation information; and an output unit that outputs the user evaluation acquired by the user feedback acquisition unit.

However, the term, “system”, as used herein refers to a logical assembly of a plurality of devices (or functional modules that implement specific functions), and each of the devices or functional modules may be or may be not in a single housing. That is, one device including a plurality of components or functional modules and an assembly of a plurality of devices correspond to the “system”.

An information processing system according to the first aspect further includes an interface presentation unit that presents an interface that inputs the user evaluation.

The system feedback acquisition unit acquires the generation data and the evaluation information from one or a plurality of devices that generates data using a generation model and evaluates the generation data using the evaluation model. Furthermore, the output unit outputs the user evaluation to a device that updates each model of a generation model that generates data and an evaluation model that evaluates the generation data.

Furthermore, a second aspect of the present disclosure is an information processing method including:
a system feedback acquisition step of acquiring generation data and evaluation information based on an evaluation model for the generation data;
a system feedback presentation step of presenting the generation data and the evaluation information;
a user feedback acquisition step of acquiring a user evaluation for the generation data or the evaluation information; and
an output step of outputting the user evaluation acquired by the user feedback acquisition step.

Furthermore, a third aspect of the present disclosure is an information processing system including:
an evaluation unit that, by using an evaluation model, generates evaluation information for generated data;
an acquisition unit that acquires user evaluation information for the evaluation information; and
an evaluation model update unit that updates the evaluation model on the basis of the user evaluation information.

An information processing device according to a third aspect further including: a generation unit that generates data using a generation model; and a generation model update unit that updates the generation model on the basis of the user evaluation information, in which the evaluation unit generates evaluation information for the data generated by the generation unit.

The evaluation unit outputs the evaluation information to an information terminal. Then, the acquisition unit acquires, from the information terminal, user evaluation information input through an interface presented on the information terminal.

Furthermore, a fourth aspect of the present disclosure is an information processing method including:
an evaluation step of, by using an evaluation model, generating evaluation information for generated data;
an acquisition step of acquiring user evaluation information for the evaluation information; and
an evaluation model update step of updating the evaluation model on the basis of the user evaluation information.

### Effects of the Invention

According to the present disclosure, it is possible to provide an information processing system and an information processing method for acquiring a user's evaluation for a simulated subjective evaluation by a machine learning model, and an information processing system and an information processing method for, by using a machine learning model, generating a subjective evaluation for subjective data generated by using a machine learning model.

Note that the effects described in the present specification are merely examples, and the effects to be brought by the present disclosure are not limited thereto. Furthermore, in addition to the effects described above, the present disclosure might further exhibit additional effects in some cases.

Still another object, feature, and advantage of the present disclosure will become clear by further detailed description with reference to an embodiment as described later and the attached drawings.

### BRIEF DESCRIPTION OF DRAWINGS

FIG. 1 is a diagram illustrating a configuration example of a data generation system 100.

FIG. 2 is a flowchart illustrating a data generation, evaluation, and learning procedure in the data generation system 100.

FIG. 3 is a diagram illustrating a generator 101 in a data generation phase.

FIG. 4 is a diagram illustrating the generator 101 and an evaluator 102 in an evaluation phase.

FIG. 5 is a diagram illustrating a generation model and an evaluation model in a model update phase.

FIG. 6 is a diagram illustrating a configuration example (first example) of an interface used for system feedback and user feedback.

FIG. 7 is a diagram illustrating a configuration example (second example) of an interface used in system feedback and user feedback.

FIG. 8 is a diagram illustrating a configuration example (third example) of an interface used in system feedback and user feedback.

FIG. 9 is a diagram illustrating a configuration example (fourth example) of an interface used in system feedback and user feedback.

FIG. 10 is a diagram illustrating a configuration example (fifth example) of an interface used for system feedback and user feedback.

FIG. 11 is a diagram illustrating a configuration example (sixth example) of an interface used for system feedback and user feedback.

FIG. 12 is a diagram illustrating a configuration example (seventh example) of an interface used for system feedback and user feedback.

FIG. 13 is a diagram illustrating a path for transferring data between phases.

FIG. 14 is a diagram illustrating a specific data flow between phases.

FIG. 15 is a diagram illustrating a configuration example of an information processing system 1500.

### MODE FOR CARRYING OUT THE INVENTION

In the description below, the present disclosure will be explained in the following order, with reference to the drawings.
A. Overview
B. Procedures of data generation, evaluation, and learning
C. Configuration example of interface
D. Details of procedures of data generation, evaluation, and learning
E. Information processing system

### A. Overview

The present disclosure relates to a technique for generating data reflecting subjectivity and preference of a user using a machine learning model. The data is various such as an image, a voice (including music), and a text. Hereinafter, for convenience, an embodiment in which data is limited to an image will be described.

The GAN is a technology for generating data whose authenticity is difficult to identify by mutual learning between a generator that generates data and a discriminator that identifies the authenticity of the generated data. On the other hand, the present disclosure is a technique of generating data reflecting the subjectivity and preference of a user by using a generator that generates data and an evaluator that evaluates the generated data subjectively of a specific user.

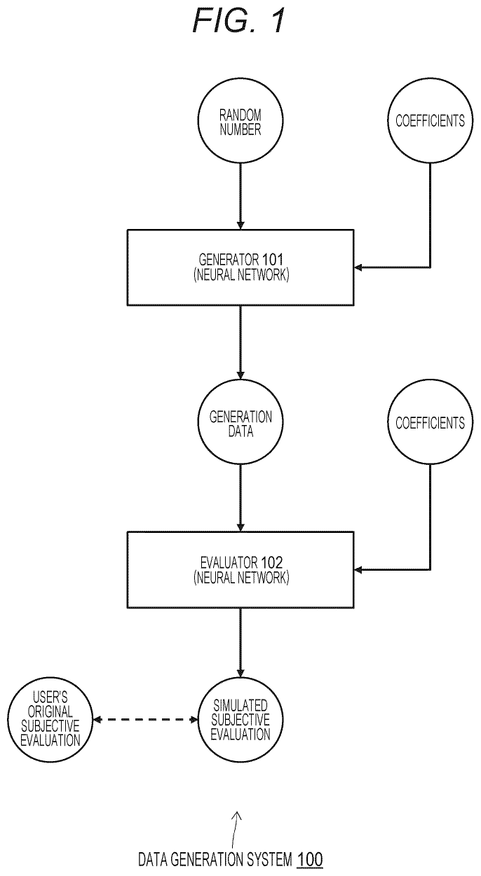

FIG. 1 schematically illustrates a configuration example of a data generation system 100 that generates data reflecting the subjectivity and preference of the user.

The data generation system 100 includes a generator 101 that generates an image and an evaluator 102 that evaluates the image generated by the generator 101 according to the subjectivity or preference of the user. Each of the generator 101 and the evaluator 102 is a machine learning model including a neural network, and generates an image and performs subjective evaluation of the generated image by setting a parameter (coefficient of each neuron) acquired at the time of learning.

FIG. 1 illustrates the generator 101 in a data generation phase and the evaluator 102 in a data evaluation phase. The generator 101 includes a neural network in which coefficients acquired at the time of learning are set, receives a random number, and outputs a newly generated image. Furthermore, the evaluator 102 includes a neural network in which coefficients acquired at the time of learning are set, receives the image generated by the generator 101, and outputs a simulated subjective evaluation in which a subjective evaluation of a specific user for the generated image is estimated.

The generator 101 updates the coefficients of the neural network so that the simulated subjective evaluation of the evaluator 102 on its own generation data is better. If the evaluator 102 has a subjective evaluation model created in a form reflecting the original subjectivity and preference of the user, the generator 101 can learn to generate data reflecting the subjectivity and preference of the user by such update processing.

Here, a neural network is used for modeling the subjective evaluation in the evaluator 102, but there is a problem that an evaluation index is greatly affected by a purpose or an individual difference. Therefore, it is desirable to be able to create a subjective evaluation model different for each purpose in a short time and at low cost, and it is more preferable to provide a method of creating a subjective evaluation model in a form capable of reflecting the subjectivity and preference for each user.

For example, there is no interface or evaluation index for reflecting user's intention in data generation in the conventional data generation technology, such as a discriminator used in GAN or LPIPS as an image quality evaluation index.

Therefore, in the present disclosure, the data generated by the generator 101 is cut out for each of various elements and mathematically modeled as an evaluation index, and an interface in which each evaluation index can be adjusted by the user is prepared. Furthermore, in the present disclosure, generation data related to data generated by the generator 101 is newly generated, these generation data are relatively subjectively evaluated, and the result is modeled. The data (such as images) generated by the generator 101 has various features. According to the present disclosure, it is possible to perform detailed user feedback in which the user appropriately adjusts a gain of each feature included in the generation data via the interface, and perform simple user feedback in which the quality of the related generation data is determined. Therefore, according to the present disclosure, a model evaluation index reflecting a lot of user's intention is realized, and automatic generation of data (that is, data reflecting the subjectivity and preference of the user) considered to be good for the user is easily realized.

### B. Learning Procedure

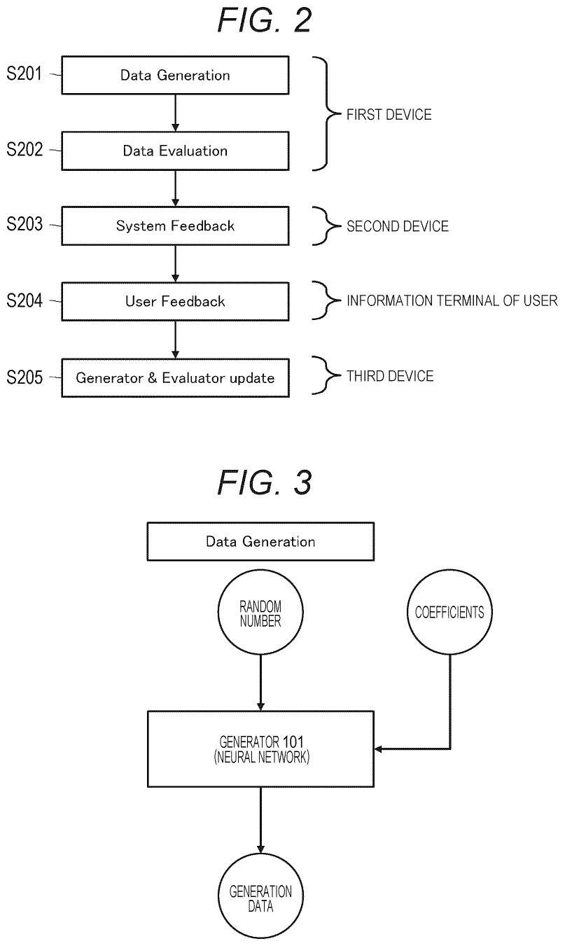

FIG. 2 illustrates a data generation, evaluation, and learning procedure in the data generation system 100 to which the present disclosure is applied in the form of a flowchart.

In a data generation phase, the generator 101 receives a random number and outputs a newly generated image (step S201).

Next, in a data evaluation phase of the generation data, the evaluator 102 receives the image generated by the generator 101 and outputs a simulated subjective evaluation that simulates a subjective evaluation of a specific user for the generated image (step S202).

Next, in a feedback (System Feedback) phase from the data generation system 100 to the user, the data newly generated by the generator 101 in the data generation phase and the simulated subjective evaluation output to the generation data by the evaluator 102 in the data evaluation phase are presented to the user (step S203).

Next, in a user feedback phase, the user feeds back the generation data of the generator 101 and the simulated subjective evaluation of the evaluator 102 to the data generation system 100 (step S204).

In the preceding data evaluation phase, the evaluator 102 outputs the simulated subjective evaluation on the generation data with an evaluation index obtained by dividing a feature of the generation data into a plurality of elements. In the subsequent system feedback phase, the simulated subjective evaluation for each evaluation index is presented to the user together with the generation data. Then, in this user feedback phase, the user feeds back the user's own subjective evaluation for each evaluation index to the data generation system 100. In steps S203 to S204, an interface for presenting the generation data and the simulated subjective evaluation to the user and an interface for inputting the original subjective evaluation of the user with respect to the generation data are prepared. The interface for inputting the user's own subjective evaluation may be an interface in which the user adjusts the evaluation index for each element of the simulated subjective evaluation. Details of these interfaces will be described later.

Then, in a model update (Generator & Evaluator update) phase of the generator 101 and the evaluator 102, the coefficients of the respective neural networks constituting the generator 101 and the evaluator 102 are updated on the basis of the feedback from the user in the preceding user feedback phase (step S205).

FIG. 3 illustrates the generator 101 in the data generation phase. In the data generation phase, coefficients acquired at the time of learning are set in the neural network constituting the generator 101, a random number is input, and newly generated data is output.

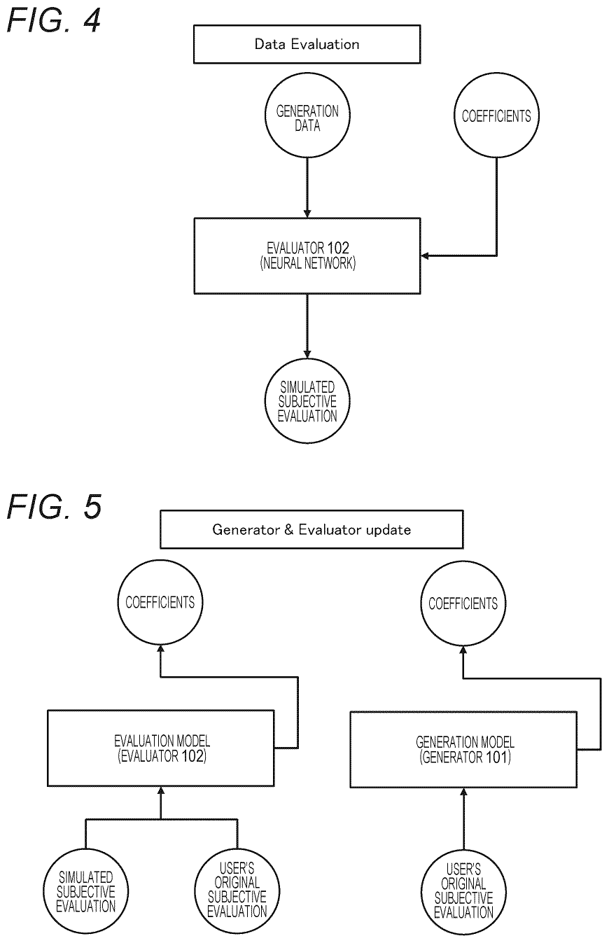

FIG. 4 illustrates the evaluator 102 in the data evaluation phase of the generation data. In the evaluation phase of the generation data, coefficients acquired at the time of learning are set in the neural network constituting the evaluator 102, the generation data of the generator 101 is input, and a simulated subjective evaluation in which the subjective evaluation of the user for the generation data is estimated is output.

FIG. 5 illustrates a generation model and an evaluation model in the model update phase. In the learning phase, coefficients of the neural network constituting each of the generator 101 and the evaluator 102 are updated (Generator & Evaluator update). In the example illustrated in FIG. 3, the coefficients of the respective neural networks are updated on the basis of the user evaluation (User Feedback) for the data newly generated by the generator 101.

Specifically, the simulated subjective evaluation of the evaluator 102 with respect to the generation data of the generator 101 and the user feedback are input to the evaluation model. For example, the simulated subjective evaluation is output as an evaluation index obtained by dividing the feature of the generation data into a plurality of elements, and the user feedback is adjustment for the simulated subjective evaluation for each evaluation index. Then, the coefficients of the neural network are updated such that a loss function based on an error with respect to the user feedback of the simulated subjective evaluation is minimized. In this way, the evaluator 102 is learned so that the simulated subjective evaluation reflecting the user's subjectivity and preference can be obtained for the newly generation data of the generator 101. Furthermore, the generator 101 inputs the user feedback for the generation data of the generator 101 itself, and updates the coefficients of the neural network so that the user feedback becomes better. In this manner, the generator 101 is learned so that data reflecting the subjectivity and preference of the user can be generated.

Note that all the phases in FIG. 2 may be implemented on a single device, but the processing of each phase may be distributed and implemented to a plurality of devices. For example, in the user feedback phase, it is conceivable to implement in an information terminal (smartphone, tablet, personal computer, etc.) possessed by the user for convenience of an operation directly input by the user. On the other hand, in each phase of data generation, data evaluation, coefficient update, and the like, a neural network is handled, and a calculation load is large. Therefore, it is conceivable to implement the neural network in a device with high calculation capability on a cloud. For example, each phase of data generation by the generator 101 and evaluation by the evaluator 102 may be implemented in a first device, a system feedback phase of presenting the generation data and the simulated subjective data to the user may be implemented in a second device, and a data update phase based on the user feedback may be implemented in a third device. Furthermore, the second device that presents the generation data and the simulated subjective data to the user in the system feedback phase and an information terminal that receives the user feedback in the user feedback phase may be the same device. In this case, the user may perform the user feedback by operating a mouse, a keyboard, a touch panel, or the like on the basis of the generation data and the simulated subjective data displayed on the information terminal.

### C. Configuration Example of Interface

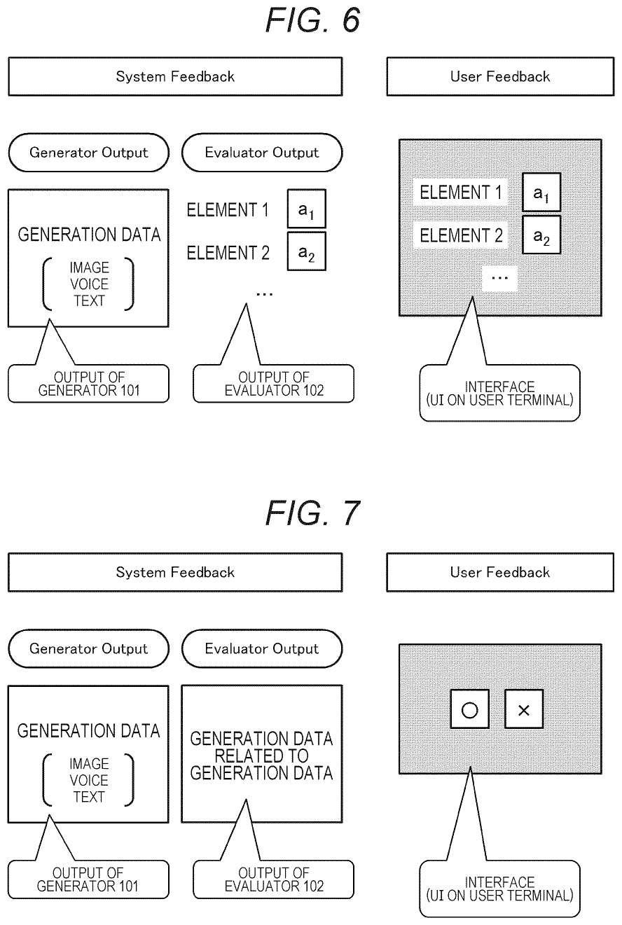

In this section, a configuration example of an interface used for system feedback and user feedback will be described with reference to FIGS. 6 to 12.

In a first example illustrated in FIG. 6, it is assumed that the evaluator 102 performs simulated subjective evaluation for each element by dividing a feature of data generated by the generator 101 into a plurality of elements. Then, in the system feedback phase illustrated in the left half of FIG. 6, data newly generated by the generator 101 (Generator Output) and simulated subjective evaluation (Evaluator Output) output by the evaluator 102 by dividing the feature of the generation data into a plurality of elements are simultaneously presented to the user. Furthermore, in the user feedback phase illustrated in the right half of FIG. 6, for example, an interface for the user to adjust the simulated subjective evaluation for each element is prepared on a screen of the information terminal used by the user. The user may make the user feedback by adjusting, via the interface, evaluation values of some elements that characterize the generation data presented in the system feedback. As illustrated in the right half of FIG. 6, a screen equipped with an interface for adjusting an evaluation value a₁ of an element 1 and an evaluation value a₂ of an element 2, respectively, is presented. The user can change each evaluation value through, for example, manual input, operation of up and down cursor buttons, dial operation, or the like.

As illustrated in FIG. 6, the subjectivity and preference of the user can be reflected in detail in the data generation system 100 by using an interface that adjusts the plurality of elements that characterize the generation data.

In a second example illustrated in FIG. 7, it is assumed that the evaluator 102 outputs generation data related to the generation data by the generator 101 as a simulated subjective evaluation. Here, “related” means, for example, “evaluated as data intended by the user”. In the system feedback phase illustrated in the left half of FIG. 7, data newly generated by the generator 101 (Generator Output) and related generation data output by the evaluator 102 (Evaluator Output) are simultaneously presented to the user. Then, in the user feedback phase illustrated in the right half of FIG. 7, for example, an interface for indicating whether or not the related generation data as the simulated subjective evaluation is data intended by the user is prepared on the screen of the information terminal used by the user. The user can perform the user feedback by indicating, through the interface, whether or not the related generation data presented in the system feedback is the data intended by the user. In the screen configuration example illustrated in the right half of FIG. 7, o and x buttons for the user to evaluate the quality of the related generation data are prepared, and the user can select any button through a mouse operation or a screen touch operation.

As illustrated in FIG. 7, it is possible to easily reflect the subjectivity and preference of the user in the data generation system 100 by presenting the generation data related to the generation data as the simulated subjective evaluation and using an interface that simply inputs an opinion on the related generation data.

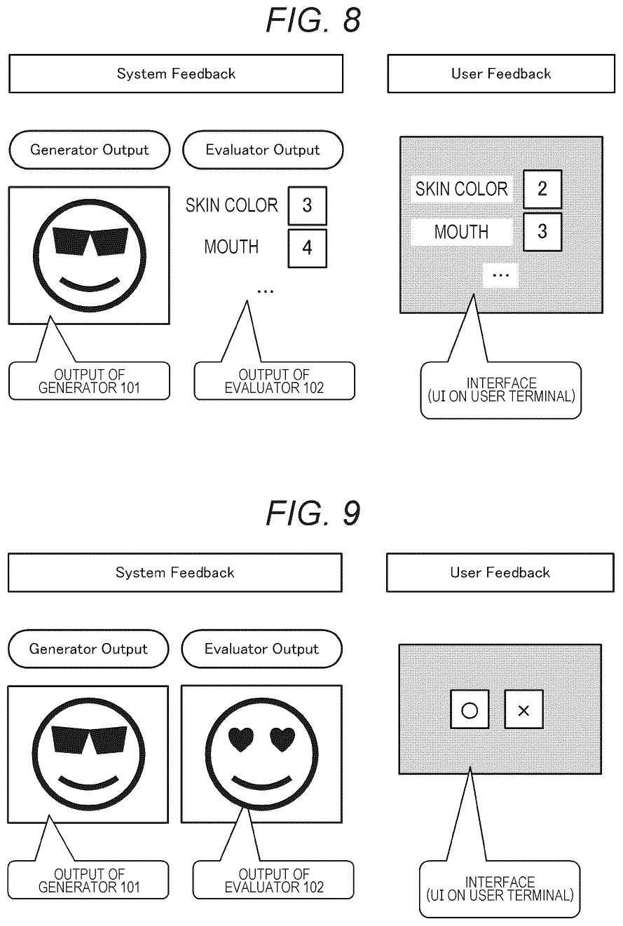

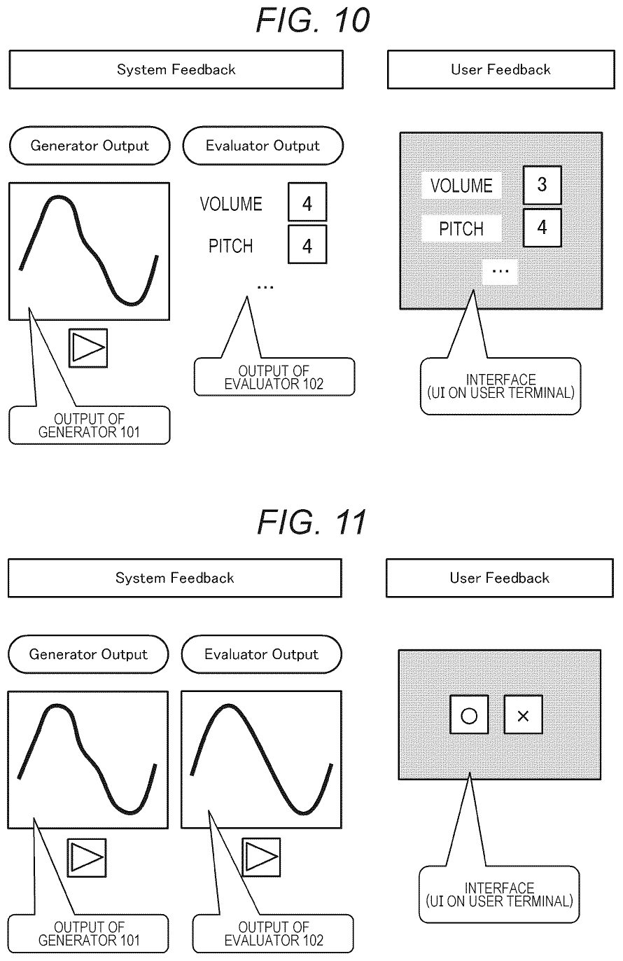

FIGS. 8 to 12 illustrate a specific configuration example of an interface for each data type of data generated by the generator 101. Among these, FIGS. 8 and 9 illustrate a specific configuration example of an interface in a case where the generator 101 generates a face image, FIGS. 10 and 11 illustrate a specific configuration example of an interface in a case where the generator 101 generates a voice, and FIG. 10 illustrates a specific configuration example of an interface in a case where the generator 101 generates advertisement content.

In a third example illustrated in FIG. 8, it is assumed that the evaluator 102 divides a feature of a face image generated by the generator 101 into a plurality of elements and performs a simulated subjective evaluation for each element. Then, in the system feedback phase illustrated in the left half of FIG. 8, a face image (Generator Output) newly generated by the generator 101 and a simulated subjective evaluation (Evaluator Output) output by the evaluator 102 by dividing a feature of the face image into a plurality of elements such as a skin color and a mouth are simultaneously presented to the user. Then, in the user feedback phase illustrated in the right half of FIG. 8, for example, an interface for the user to adjust the simulated subjective evaluation for each element such as a skin color or a mouth is prepared on the screen of the information terminal used by the user. The user can perform the user feedback by adjusting, via the interface, evaluation values of some elements that characterize the face image presented in the system feedback. The user can perform, on the interface, feedback of the subjective evaluation by the user himself/herself such as “making the skin color darker” or “making the mouth feel larger” in the form of changing the subjective index value, and perform detailed user feedback to the data generation system 100. The subjective index value can be changed, for example, through manual input of a numerical value on the screen, operation of up and down cursor buttons, dial operation, or the like.

As illustrated in FIG. 8, the subjectivity and preference of the user can be reflected in detail in the data generation system 100 by using an interface for adjusting a plurality of elements characterizing the generated face image.

In a fourth example illustrated in FIG. 9, it is assumed that the evaluator 102 outputs a face image related to the face image generated by the generator 101 as a simulated subjective evaluation. In the system feedback phase illustrated in the left half of FIG. 9, the face image (generator output) newly generated by the generator 101 and the related face image (evaluator output) generated by the evaluator 102 are simultaneously presented to the user. Then, in the user feedback phase illustrated in the right half of FIG. 9, for example, an interface for indicating whether or not the related face image as the simulated subjective evaluation is the face image intended by the user is prepared on the screen of the information terminal used by the user. The user can easily perform the user feedback by indicating, through the interface, whether or not the related face image presented in the system feedback is the face image intended by the user. In the screen configuration example illustrated in the right half of FIG. 9, o and x buttons for the user to evaluate the quality of the related face image are prepared, and the user can select any button through a mouse operation or a screen touch operation.

As illustrated in FIG. 9, the face image related to the generated face image is presented as the simulated subjective evaluation, and the subjectivity and preference of the user can be easily reflected in the data generation system 100 by using the interface for simply inputting an opinion on the related face image.

In a fifth example illustrated in FIG. 10, it is assumed that the evaluator 102 divides a feature of a voice generated by the generator 101 into a plurality of elements and performs a simulated subjective evaluation for each element. In the system feedback phase illustrated in the left half of FIG. 10, a voice (Generator Output) newly generated by the generator 101 and a simulated subjective evaluation (Evaluator Output) output by the evaluator 102 by dividing a feature of the voice into a plurality of elements such as a volume and a pitch are simultaneously presented to the user. The user can reproduce the generated voice to check features such as volume and pitch. Then, in the user feedback phase illustrated in the right half of FIG. 10, for example, an interface for the user to adjust the simulated subjective evaluation for each element such as volume and pitch is prepared on the screen of the information terminal used by the user. The user can perform the user feedback by adjusting, via the interface, evaluation values of some elements that characterize the voice presented in the system feedback. The user can perform, on the interface, feedback of the subjective evaluation by the user himself or herself, such as “reducing the volume” or “increasing the pitch”, in the form of adjustment of the subjective index value, and perform detailed user feedback to the data generation system 100. As illustrated in the right half of FIG. 10, a screen equipped with an interface for adjusting each evaluation value of the volume and the pitch is presented. The user can change each evaluation value through, for example, manual input, operation of up and down cursor buttons, dial operation, or the like.

As illustrated in FIG. 10, the subjectivity and preference of the user can be reflected in detail in the data generation system 100 by using an interface that adjusts a plurality of elements characterizing the generated voice.

In a sixth example illustrated in FIG. 11, it is assumed that the evaluator 102 outputs a voice related to the voice generated by the generator 101 as a simulated subjective evaluation. In the system feedback phase illustrated in the left half of FIG. 11, a voice (Generator Output) newly generated by the generator 101 and a related voice (Evaluator Output) generated by the evaluator 102 are simultaneously presented to the user. The user can reproduce the generated voice and the related voice to check features such as volume and pitch of each voice. Then, in the user feedback phase illustrated in the right half of FIG. 11, for example, an interface for indicating whether or not the related voice as the simulated subjective evaluation is the voice intended by the user is prepared on the screen of the information terminal used by the user. The user can easily perform the user feedback by indicating, through the interface, whether or not the related voice presented in the system feedback is the voice intended by the user. In the screen configuration example illustrated in the right half of FIG. 11, o and x buttons for the user to evaluate the quality of the related voice are prepared, and the user can select one of the buttons through a mouse operation or a screen touch operation.

As illustrated in FIG. 11, it is possible to easily reflect the subjectivity and preference of the user in the data generation system 100 by presenting a voice related to the generated voice as the simulated subjective evaluation and using an interface that simply inputs an opinion on the related voice.

For example, for a subjective evaluation in a case where content of a color image is generated from content of a black-and-white image using the data generation system 100, learning of the generator 101 and the evaluator 102 by feedback of the subjective evaluation through the interfaces illustrated in FIGS. 8 and 9 can be performed.

Furthermore, for the subjective evaluation in a case where a voice effect of the video content is generated using the data generation system 100, it is possible to perform learning of the generator 101 and the evaluator 102 by feedback of the subjective evaluation through the interfaces illustrated in FIGS. 10 and 11.

Furthermore, for the subjective evaluation in a case where a character image of animation or a voice of a character is generated using the data generation system 100, it is possible to learn the generator 101 and the evaluator 102 by feedback of the subjective evaluation through the interfaces illustrated in FIGS. 8 to 11.

Furthermore, in the user feedback phase in the examples illustrated in FIGS. 8 to 11, the user may select a part of the data newly generated by the generator 101 so that the user feedback for the selected part can be performed. In the examples illustrated in FIGS. 8 and 10, for example, in a case where the user selects a part of the content, an interface for evaluating an element corresponding to the selected part is presented. Furthermore, in the examples illustrated in FIGS. 9 and 11, for example, in a case where the user selects a part of the content, an interface for evaluating whether or not the selected part is data intended by the user is presented.

In a case where the content corresponding to the Generator Output and the Evaluator Output is presented on the information terminal that receives the user feedback, the user may select a part of the content presented on the information terminal using a mouse, a keyboard, a touch panel, or the like, and an interface for performing the user feedback may be presented at a position corresponding to the content selection position.

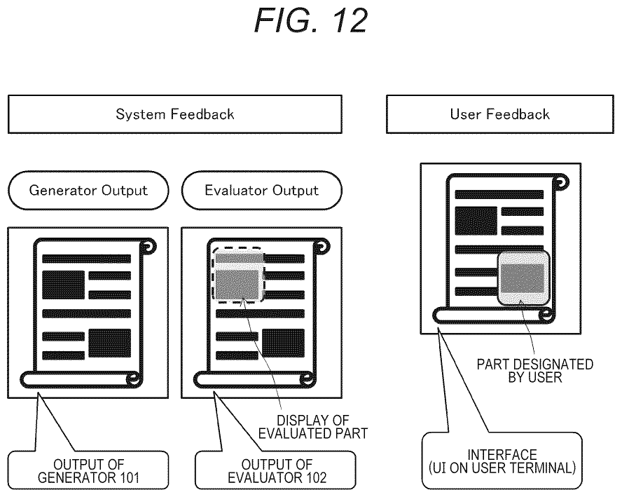

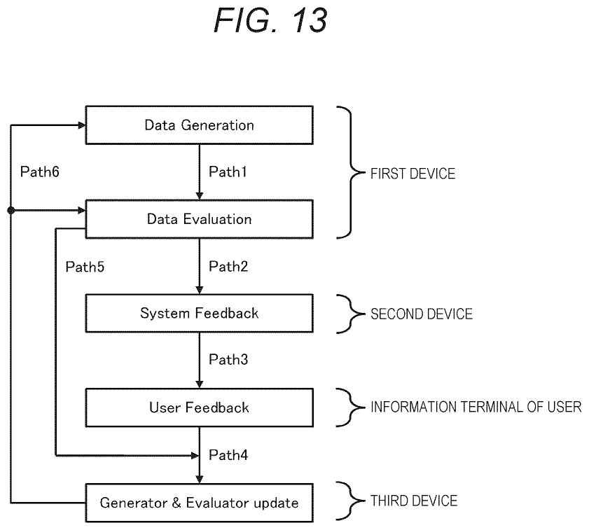

In a seventh example illustrated in FIG. 12, it is assumed that the evaluator 102 performs a simulated subjective evaluation as to which part the user wants to emphasize in the advertisement content generated by the generator 101. In the system feedback phase illustrated in the left half of FIG. 12, the advertisement content (generator output) generated by the generator 101 and the advertisement content (evaluator output) including designation of a part that the user wants to emphasize and is simulated and subjectively evaluated by the evaluator 102 in the advertisement content are simultaneously presented to the user. Then, in the user feedback phase illustrated in the right half of FIG. 12, for example, an interface for indicating a part that the user originally wants to emphasize on the advertisement content is prepared on the screen of the information terminal used by the user. The user can perform user feedback by instructing a part that the user originally wants to emphasize in the advertisement content via the interface. Note that the advertisement content corresponding to the Evaluator Output is not limited to the advertisement content including the designation of the part that the user desires to emphasize and is subjected to the simulated subjective evaluation, and the part designated by the simulated subjective evaluation may be presented as the advertisement content in which the part is actually emphasized. Similarly, advertisement content in which a part designated by the user is emphasized may be presented also in an interface presented on a screen of an information terminal used by the user.

In a case where an advertisement is automatically generated using the data generation system 100, it is possible to learn the generator 101 and the evaluator 102 by feedback of subjective evaluation through the interface illustrated in FIG. 12.

As illustrated in FIG. 12, advertisement content including designation of a part that the user has imaged subjective evaluation that the user wants to emphasize in the generated advertisement content is presented as the imaged subjective evaluation, and the subjectivity and preference of the user can be easily reflected in the data generation system 100 by using the interface that simply designates the part that the user originally wants to emphasize in the advertisement content.

### D. Details of Procedures of Data Generation, Evaluation, and Learning

In the section B described above, the procedures of data generation, evaluation, and learning in the data generation system 100 have been schematically described. In this D section, details of procedures when data generation, evaluation, and learning are performed in the data generation system 100 will be described including a data flow.

Here, it is assumed that each phase of data generation by the generator 101 and evaluation by the evaluator 102 is implemented in a first device, a system feedback phase of presenting the generation data and the simulated subjective data to the user is implemented in a second device, a data update phase based on the user feedback is implemented in a third device, and a user feedback phase is implemented in a user terminal.

Furthermore, FIG. 13 illustrates a path for transferring data between the phases. As illustrated in the drawing, a data transfer path from the data generation phase to the data evaluation phase is defined as Path1, a data transfer path from the data evaluation phase to the system feedback phase is defined as Path2, a data transfer path from the system feedback phase to the user feedback phase is defined as Path3, a data transfer path from the user feedback phase to the model update phase is defined as Path4, a data transfer path from the data evaluation phase to the model update phase is defined as Path5, and a data transfer path from the model update phase to the data generation phase is defined as Path6. In a case where each phase is implemented in a distributed manner in a plurality of physically independent devices such as the first to third devices and the user information terminal, the Path1 to Path6 includes a communication medium that connects the corresponding devices. Furthermore, a data transfer path (for example, Path1 between the data generation phase and the data evaluation phase) between a plurality of phases implemented in a single device is implemented by, for example, communication between applications.

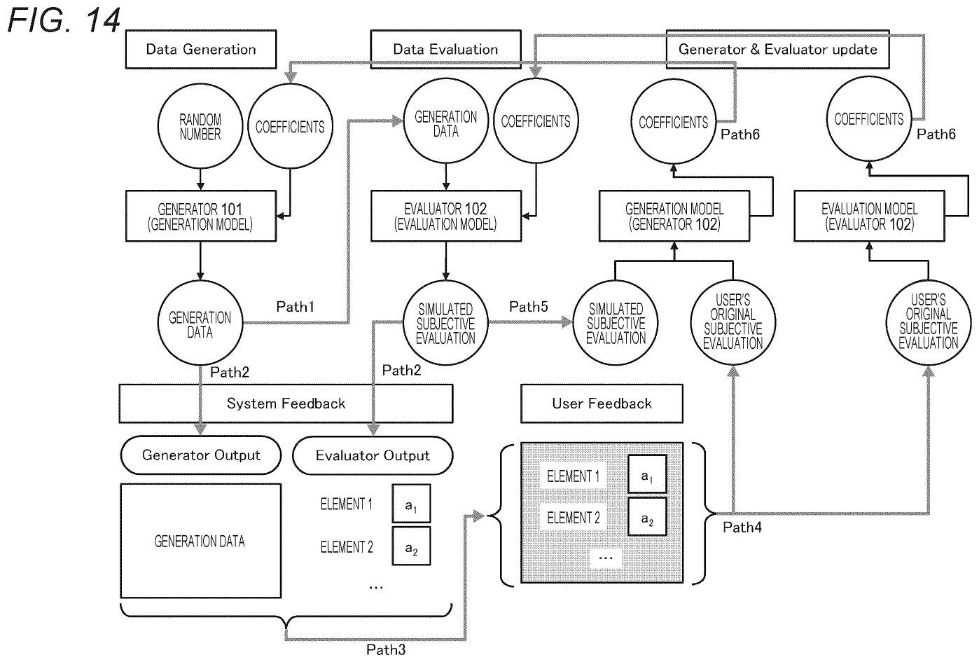

FIG. 14 illustrates a specific data flow between the phases.

In the data generation phase, coefficients acquired at the time of learning are set in the neural network constituting the generator 101, a random number is input, and newly generated data is output. The generation data is transferred to the data evaluation phase via Path1.

In the evaluation phase of the generation data, coefficients acquired at the time of learning are set in the neural network constituting the evaluator 102, the generation data is input via Path1, and a simulated subjective evaluation in which the subjective evaluation of the user for the generation data is estimated is output.

In the system feedback phase, in the second device that performs system feedback, data (generator output) newly generated by the generator 101 and a simulated subjective evaluation (evaluator output) output by the evaluator 102 by dividing a feature of the generation data into a plurality of elements are acquired via Path2, and these are simultaneously presented to the user.

In the user feedback phase, for example, the simulation evaluation result acquired via Path3 is presented on an interface for the user to adjust the simulation subjective evaluation for each element, which is displayed on a screen of an information terminal used by the user. Then, the user can adjust, through an interface on a screen of the information terminal, the evaluation values of some elements that characterize the generation data.

In the model update phase, the third device that learns the generation model used by the generator 101 and the evaluation model used by the evaluator 102 acquires the simulated subjective evaluation on the generation data by the evaluator 102 via Path5 and acquires the user feedback on the simulated subjective evaluation via Path4. Here, the simulated subjective evaluation of the evaluator 102 with respect to the generation data of the generator 101 and the user feedback are input to the evaluation model. In the example illustrated in FIG. 14, the simulated subjective evaluation is an evaluation index obtained by dividing a feature of the generation data into a plurality of elements, and the user feedback is adjustment for the simulated subjective evaluation for each evaluation index. Then, in the third device, the coefficients of the neural network constituting the evaluation model are updated such that a loss function based on an error with respect to the user feedback of the simulated subjective evaluation is minimized. Furthermore, user feedback for the simulated subjective evaluation of the generation data is input to the generation model. Then, in the third device, the coefficients of the neural network constituting the generation model are updated so that the user feedback becomes better.

Then, the coefficients of the generation model updated in the model update phase are set to the generation model used by the generator 101 via Path6 and used in the next data generation phase. Furthermore, the coefficients of the evaluation model updated in the model update phase are used in the next data evaluation phase set in the evaluation model used by the evaluator 102 via Path 6.

Although the evaluation index of the subjective evaluation is affected by a purpose or an individual difference, according to the present disclosure, different subjective evaluation models can be created in a short time and at a low cost according to a procedure as illustrated in FIG. 14. Furthermore, according to the present disclosure, since the interface that reflects the intention of the user in the evaluation model is provided, it is possible to provide the data processing system 100 that learns the evaluation model in a form that can reflect the subjectivity and preference of the user and generates data as intended by the user.

### E. Information Processing System

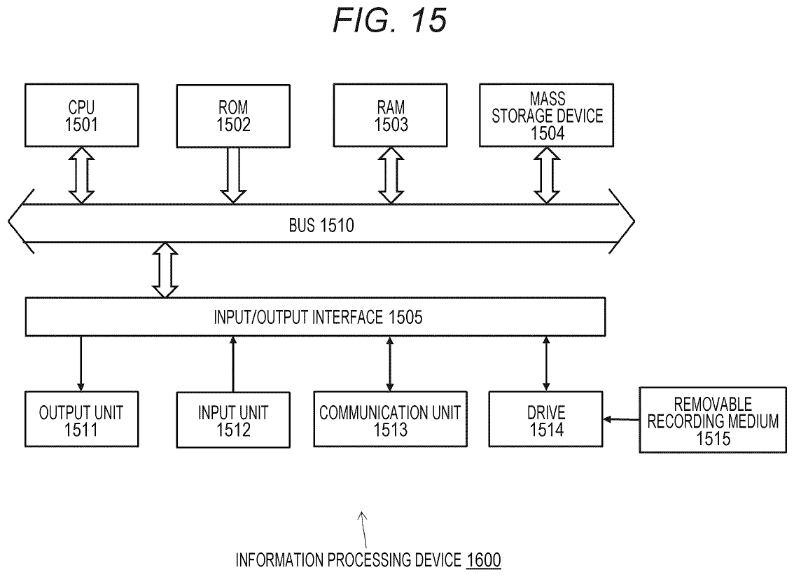

FIG. 15 illustrates a configuration example of an information processing system 1500 used as, for example, the first to third devices or the information terminal of the user. Each element of the information processing system 1500 will be described below.

A central processing unit (CPU) 1501 is interconnected with each unit of a read only memory (ROM) 1502, a random access memory (RAM) 1503, a mass storage device 1504, and an input/output interface 1505 via a bus 1610.

The CPU 1501 executes a program loaded from the ROM 1502 or the mass storage device 1504 to the RAM 1503, and can realize various processes while temporarily holding the work data being executed in the RAM 1503. Examples of the program executed by the CPU 1501 include a basic input/output program stored in the ROM 1502 and an operating system (OS) and an application program installed in the mass storage device 1504. The OS provides an execution environment of an application program. Furthermore, the application program includes an application program that performs at least one of learning processing of a machine learning model, generation of data using a learned machine learning model, estimation of a subjective evaluation of generation data, presentation of generation data and its simulated subjective evaluation, acquisition of user feedback for the simulated subjective evaluation, or the like. The information processing system 1500 operates as various devices related to the present disclosure by the CPU 1501 executing an application program under an execution environment provided by the OS.

Note that since processing related to a machine learning model such as learning is enormous in calculation amount and parallel processing is conceivable, the information processing system 1500 may include a graphics processing unit (GPU) or general-purpose computing on graphics processing units (GPGPU) instead of the CPU 1501 or together with the CPU 1501.

The ROM 1502 is a read-only memory that permanently stores basic input/output programs, device information, and the like. The RAM 1503 includes a volatile memory such as a dynamic RAM (DRAM) and is used as a work area of the CPU 1501. The mass storage device 1504 is a hard disc drive (HDD), a solid state drive (SSD), or the like, and stores programs and data in a file format. The HDD is a storage device using one or a plurality of magnetic disks fixed in a unit as a recording medium.

Various input/output devices such as an output unit 1511, an input unit 1512, a communication unit 1513, and a drive 1514 are connected to the input/output interface 1505. The output unit 1511 includes a liquid crystal display (LCD), a speaker, a printer, and the like, and outputs, for example, a program execution result by the CPU 1501. The input unit 1512 includes a keyboard, a mouse, a microphone, and the like, and receives an instruction from the user.

The communication unit 1513 includes a wired or wireless communication interface conforming to a predetermined communication protocol, and performs data communication with an external device. In a case where the information processing system 1500 operates as any of the first to third devices, the communication unit 1513 communicates with other devices among the first to third devices. Furthermore, in a case where the information processing system 1500 operates as the information terminal of the user, the communication unit 1513 communicates with the second device and the third device.

Furthermore, the communication unit 1513 is connected to a wide area network such as the Internet. The application program can be downloaded from a download site on the Internet using the communication unit 1516 and installed in the information processing system 1500.

The drive 1514 loads a removable recording medium 1515 and performs read processing from the removable recording medium 1515 and write processing (however, in the case of a writable recording medium,) to the removable recording medium 1515. The removable recording medium 1515 records programs, data, and the like in a file format. Examples of the removable recording medium 1515 include a flexible disk, a compact disc read only memory (CD-ROM), a magneto optical (MO) disk, a digital versatile disc (DVD), a magnetic disk, a semiconductor memory, and the like.

The information processing system 1500 can operate as the first device by installing, for example, a program for generating data using the generation model and a program for estimating a subjective evaluation of data using the evaluation model.

Furthermore, the information processing system 1500 can operate as the second device by installing a program that acquires and presents the generation data by the generation model and the simulated subjective evaluation on the generation data by the evaluation model.

Furthermore, the information processing system 1500 presents an interface for inputting the generation data by the generation model and the evaluation by the user for the simulated subjective evaluation on the generation data by the evaluation model, and installs a program for uploading the evaluation fed back from the user acquired via the interface, thereby operating as the information terminal of the user.

Furthermore, the information processing system 1500 can operate as the third device by installing a program for performing learning (That is, the coefficient of each neural network is updated.) of the generation model and the evaluation model on the basis of the simulated subjective evaluation on the generation data by the evaluation model and the evaluation fed back from the user.

### INDUSTRIAL APPLICABILITY

The present disclosure has been described in detail above with reference to the specific embodiments. However, it is obvious that those skilled in the art can make modifications and substitutions of the embodiments without departing from the gist of the present disclosure.

In the present specification, the embodiment in which the present disclosure is mainly applied to a data generation system that generates an image has been mainly described, but the gist of the present disclosure is not limited thereto. The present disclosure can be applied to generation of various data such as voice, music, and text in addition to images, and a subjective evaluation of the generated data.

Furthermore, the evaluation model learned on the basis of the present disclosure can be applied to a subjective evaluation of content of a color image generated from content of a black-and-white image, a subjective evaluation of a voice effect generated from video content, and a subjective evaluation of a character image of an automatically generated animation or voice of a character.

In short, the present disclosure has been described in the form of exemplification, and thus the contents described herein should not be construed in a limited manner. To determine the gist of the present disclosure, the scope of claims should be taken into consideration.

Note that the present disclosure can have the following configurations.

(1) An information processing system including:
a system feedback acquisition unit that acquires generation data and evaluation information based on an evaluation model for the generation data;
a system feedback presentation unit that presents the generation data and the evaluation information;
a user feedback acquisition unit that acquires a user evaluation for the generation data or the evaluation information; and an output unit that outputs the user evaluation acquired by the user feedback acquisition unit.

(2) The information processing system according to (1) described above, further including an interface presentation unit that presents an interface that inputs the user evaluation.

(3) The information processing system according to any one of (1) and (2) described above, in which
the system feedback acquisition unit acquires the generation data and the evaluation information from one or a plurality of devices that generates data using a generation model and evaluates the generation data using the evaluation model.

(4) The information processing system according to any one of (2) and (3) described above, in which
the system feedback acquisition unit acquires, as evaluation information for the generation data, an evaluation index obtained by dividing a feature of the generation data into a plurality of elements,
the system feedback presentation unit presents the generation data and the evaluation index for each of the elements, and
the interface presentation unit presents an interface that adjusts the evaluation index for each of the elements.

(5) The information processing system according to any one of (2) to (4) described above, in which
the system feedback acquisition unit acquires, as evaluation information for the generation data, generation data related to the generation data,
the system feedback presentation unit presents the generation data and the related generation data, and
the interface presentation unit presents an interface that inputs a user's intention for the related generation data.

(6) The information processing system according to (1) described above, in which
the output unit outputs the user evaluation to a device that updates each model of a generation model that generates data and an evaluation model that evaluates the generation data.

(7) The information processing system according to any one of (1) to (6) described above, further including:
a first device including the system feedback acquisition unit and the system feedback presentation unit; and
a second device including the user feedback acquisition unit and the output unit.

(8) The information processing system according to any one of (1) to (7) described above, further including
a third device that updates each model of a generation model that generates data and an evaluation model that evaluates the generation data,
in which the output unit outputs the user evaluation to the third device.

(9) The information processing system according to any one of (1) to (8) described above, further including
one or a plurality of devices that generates data using a generation model and evaluates the generation model using the evaluation model,
in which the system feedback acquisition unit acquires the generation data and evaluation of generation data using the evaluation model from the one or the plurality of devices.

(10) The information processing system according to any one of (1) to (9) described above, further including
a first device including the system feedback acquisition unit, the system feedback presentation unit, the user feedback acquisition unit, and the output unit.

(11) An information processing method including:
a system feedback acquisition step of acquiring generation data and evaluation information based on an evaluation model for the generation data;
a system feedback presentation step of presenting the generation data and the evaluation information;
a user feedback acquisition step of acquiring a user evaluation for the generation data or the evaluation information; and
an output step of outputting the user evaluation acquired by the user feedback acquisition step.

(12) The information processing method according to claim 11, further including an interface presentation step of presenting an interface that inputs the user evaluation.

(13) The information processing method according to (12) described above, in which
in the system feedback acquisition step, an evaluation index obtained by dividing a feature of the generation data into a plurality of elements is acquired as evaluation information for the generation data,
in the system feedback presentation step, the generation data and the evaluation index for each of the elements are presented, and
in the interface presentation step, an interface that adjusts the evaluation index for each of the elements is presented.

(14) The information processing method according to (12) described above, in which
in the system feedback acquisition step, generation data related to the generation data is acquired as evaluation information for the generation data,
in the system feedback presentation step, the generation data and the related generation data are presented, and
in the interface presentation step, an interface that inputs a user's intent for the related generation data is presented.

(15) An information processing system including:
an evaluation unit that, by using an evaluation model, generates evaluation information for generated data;
an acquisition unit that acquires user evaluation information for the evaluation information; and
an evaluation model update unit that updates the evaluation model on the basis of the user evaluation information.

(16) The information processing system according to (15) described above, further including:
a generation unit that generates data using a generation model; and
a generation model update unit that updates the generation model on the basis of the user evaluation information,
in which the evaluation unit generates evaluation information for the data generated by the generation unit.

(17) The information processing system according to any one of (15) and (16) described above, in which
the evaluation unit outputs the evaluation information to an information terminal, and
the acquisition unit acquires, from the information terminal, user evaluation information input through an interface presented on the information terminal.

(18) The information processing system according to any one of (15) to (17) described above, in which
the evaluation unit divides a feature of the generated data into a plurality of elements to perform evaluation for each of the elements, and
the acquisition unit acquires user evaluation information including information for adjusting the evaluation for each element of the plurality of elements.

(19) The information processing system according to any one of (15) to (18) described above, in which
the evaluation unit generates generation data related to the generated data, and
the acquisition unit acquires user evaluation information including a user's intention for the related generation data.

(20) An information processing method including:
an evaluation step of, by using an evaluation model, generating evaluation information for generated data;
an acquisition step of acquiring user evaluation information for the evaluation information; and
an evaluation model update step of updating the evaluation model on the basis of the user evaluation information.

(21) A data generation system including:
a generation unit that generates data using a generation model; and
an evaluation unit that, by using an evaluation model, generates a subjective evaluation of the data generated by the generation unit.

(22) The data generation system according to (21) described above, further including
a model update unit that, on the basis of user evaluation for system feedback including the generation data by the generation unit and the subjective evaluation by the evaluation unit, updates at least one of the generation model or the evaluation model.

(23) The data generation system according to (22) described above, in which
the evaluation unit generates an evaluation index obtained by dividing a feature of the generation data into a plurality of elements as a subjective evaluation on the generation data, and
the model update unit updates the model on the basis of an adjustment result by a user for the evaluation index for each of the elements.

(24) The data generation system according to (21) described above, in which
the evaluation unit generates data related to the generation data as a subjective evaluation on the generation data, and
the model update unit updates the model on the basis of a user's intention for the related data.

### REFERENCE SIGNS LIST

100 Data generation system
101 Generator
102 Evaluator
1500 Information processing system
1501 CPU
1502 ROM
1503 RAM
1504 Mass storage device
1505 Input/output interface
1510 Bus
1511 Output unit
1512 Input unit
1513 Communication unit
1514 Drive
1515 Removable recording medium

1. An information processing system comprising:
a system feedback acquisition unit that acquires generation data and evaluation information based on an evaluation model for the generation data;
a system feedback presentation unit that presents the generation data and the evaluation information;
a user feedback acquisition unit that acquires a user evaluation for the generation data or the evaluation information; and
an output unit that outputs the user evaluation acquired by the user feedback acquisition unit.

2. The information processing system according to claim 1, further comprising an interface presentation unit that presents an interface that inputs the user evaluation.

3. The information processing system according to claim 1, wherein
the system feedback acquisition unit acquires the generation data and the evaluation information from one or a plurality of devices that generates data using a generation model and evaluates the generation data using the evaluation model.

4. The information processing system according to claim 2, wherein
the system feedback acquisition unit acquires, as evaluation information for the generation data, an evaluation index obtained by dividing a feature of the generation data into a plurality of elements,
the system feedback presentation unit presents the generation data and the evaluation index for each of the elements, and
the interface presentation unit presents an interface that adjusts the evaluation index for each of the elements.

5. The information processing system according to claim 2, wherein
the system feedback acquisition unit acquires, as evaluation information for the generation data, generation data related to the generation data,
the system feedback presentation unit presents the generation data and the related generation data, and
the interface presentation unit presents an interface that inputs a user's intention for the related generation data.

6. The information processing system according to claim 1, wherein
the output unit outputs the user evaluation to a device that updates each model of a generation model that generates data and an evaluation model that evaluates the generation data.

7. The information processing system according to claim 1, further comprising:
a first device including the system feedback acquisition unit and the system feedback presentation unit; and
a second device including the user feedback acquisition unit and the output unit.

8. The information processing system according to claim 1, further comprising
a third device that updates each model of a generation model that generates data and an evaluation model that evaluates the generation data,
wherein the output unit outputs the user evaluation to the third device.

9. The information processing system according to claim 1, further comprising
one or a plurality of devices that generates data using a generation model and evaluates the generation model using the evaluation model,
wherein the system feedback acquisition unit acquires the generation data and evaluation of generation data using the evaluation model from the one or the plurality of devices.

10. The information processing system according to claim 1, further comprising
a first device including the system feedback acquisition unit, the system feedback presentation unit, the user feedback acquisition unit, and the output unit.

11. An information processing method comprising:
a system feedback acquisition step of acquiring generation data and evaluation information based on an evaluation model for the generation data;
a system feedback presentation step of presenting the generation data and the evaluation information;
a user feedback acquisition step of acquiring a user evaluation for the generation data or the evaluation information; and
an output step of outputting the user evaluation acquired by the user feedback acquisition step.

12. The information processing method according to claim 11, further comprising an interface presentation step of presenting an interface that inputs the user evaluation.

13. The information processing method according to claim 12, wherein
in the system feedback acquisition step, an evaluation index obtained by dividing a feature of the generation data into a plurality of elements is acquired as evaluation information for the generation data,
in the system feedback presentation step, the generation data and the evaluation index for each of the elements are presented, and
in the interface presentation step, an interface that adjusts the evaluation index for each of the elements is presented.

14. The information processing method according to claim 12, wherein
in the system feedback acquisition step, generation data related to the generation data is acquired as evaluation information for the generation data,
in the system feedback presentation step, the generation data and the related generation data are presented, and
in the interface presentation step, an interface that inputs a user's intent for the related generation data is presented.

15. An information processing system comprising:
an evaluation unit that, by using an evaluation model, generates evaluation information for generated data;
an acquisition unit that acquires user evaluation information for the evaluation information; and
an evaluation model update unit that updates the evaluation model on a basis of the user evaluation information.

16. The information processing system according to claim 15, further comprising:
a generation unit that generates data using a generation model; and
a generation model update unit that updates the generation model on a basis of the user evaluation information,
wherein the evaluation unit generates evaluation information for the data generated by the generation unit.

17. The information processing system according to claim 15, wherein
the evaluation unit outputs the evaluation information to an information terminal, and
the acquisition unit acquires, from the information terminal, user evaluation information input through an interface presented on the information terminal.

18. The information processing system according to claim 15, wherein
the evaluation unit divides a feature of the generated data into a plurality of elements to perform evaluation for each of the elements, and
the acquisition unit acquires user evaluation information including information for adjusting the evaluation for each element of the plurality of elements.

19. The information processing system according to claim 15, wherein
the evaluation unit generates generation data related to the generated data, and
the acquisition unit acquires user evaluation information including a user's intention for the related generation data.

20. An information processing method comprising:
an evaluation step of, by using an evaluation model, generating evaluation information for generated data;
an acquisition step of acquiring user evaluation information for the evaluation information; and
an evaluation model update step of updating the evaluation model on a basis of the user evaluation information.
